(19) United States
(12) Patent Application Publication
(10) Pub. No.: US 2017/0234308 A1
(43) Pub. Date: Aug. 17, 2017

(54) TRANSMISSION FOR PUMP SUCH AS HYDRAULIC FRACTURING PUMP

(71) Applicant: S.P.M. Flow Control, Inc., Fort Worth, TX (US)

(72) Inventor: Christopher Buckley, Tomball, TX (US)

(21) Appl. No.: 15/427,705

(22) Filed: Feb. 8, 2017

Related U.S. Application Data
(60) Provisional application No. 62/294,013, filed on Feb. 11, 2016.

(51) Int. Cl. F04B 9/02; F04B 19/20; E21B 43/26

(52) U.S. Cl. CPC F04B 9/02; E21B 43/26; F04B 19/20; F16H 3/02

(57) ABSTRACT

An apparatus and method according to which a fluid, such as a fracturing fluid, is pressurized. The apparatus includes a motor that produces a first rotational output including a first angular velocity, a pump operably coupled to the motor, the pump comprising a fluid end and a power end operably coupled to the fluid end, and a transmission operably coupled between the motor and the pump. The transmission receives the first rotational output as a first rotational input, the first rotational input including the first angular velocity, and converts the first rotational input into a second rotational output, the second rotational output including a second angular velocity. The power end receives the second rotational output as a second rotational input, the second rotational input including the second angular velocity. In some embodiments, the transmission is directly connected to, or part of, the pump and the motor.

### CROSS-REFERENCE TO RELATED APPLICATION

This application claims the benefit of the filing date of, and priority to, U.S. Application No. 62/294,013, filed Feb. 11, 2016, the entire disclosure of which is hereby incorporated herein by reference.

### TECHNICAL FIELD

This disclosure relates in general to pumps and, in particular, a transmission for a pump such as a hydraulic fracturing pump or any reciprocating pump assembly that may be used in one or more other applications or environments.

### BACKGROUND OF THE DISCLOSURE

A pump assembly may include a motor, a pump, one or more transmissions, and one or more gear reducers, with the motor, the pump, the transmission(s), and the gear reducer(s) being separate and distinct from one another. Such a pump assembly may be used to hydraulically fracture (or “frac”) a subterranean formation by pressurizing a fluid for conveyance to a wellbore that extends within a subterranean formation, thereby facilitating oil and gas exploration and production operations. The pump may include a fluid end and a power end. During the hydraulic fracturing of the subterranean formation, the transmission(s) and the gear reducer(s) transmit power from the motor to the power end of the pump. In some cases, the configuration of the transmission(s) and/or the gear reducer(s) may decrease the efficiency of the pump assembly, thereby constraining the performance of the fluid end. Such constrained performance presents a problem for operators dealing with continuous duty operations, harsh downhole environments, and multiple extended-reach lateral wells. Further, the configuration of the transmission(s) and/or the gear reducer(s) may adversely affect the size and weight of the pump assembly, and thus the transportability and overall footprint of the pump assembly at the wellsite. Finally, the separate and distinct nature of the motor, the pump, the transmission(s), and the gear reducer(s) can make it difficult to inspect, service, or repair the pump assembly, and/or to coordinate the inspection, service, repair, or replacement of the motor, the pump, the transmission(s), and/or the gear reducer(s). Therefore, what is needed is an assembly, apparatus, or method that addressed one or more of the foregoing issues, and/or other issues.

### SUMMARY

In a first aspect, there is provided a method, including providing a pump assembly including a motor, a pump operably coupled to the motor, and a transmission operably coupled between the motor and the pump, the pump including a fluid end and a power end operably coupled to the fluid end; producing, using the motor, a first rotational output, the first rotational output including a first angular velocity; receiving the first rotational output as a first rotational input of the transmission, the first rotational input including the first angular velocity; converting, using the transmission, the first rotational input into a second rotational output, the second rotational output including a second angular velocity; and receiving the second rotational output as a second rotational input of the power end, the second rotational input including the second angular velocity.

In an example embodiment, the method further includes converting, using the power end, the second rotational input into a reciprocating linear output; and receiving the reciprocating linear output as a reciprocating linear input of the fluid end, wherein the reciprocating linear input draws fluid into the fluid end, pressurizes the fluid drawn into the fluid end, and discharges the pressurized fluid out of the fluid end.

In another example embodiment, the transmission is directly connected to, or part of, the pump; and the transmission is directly connected to, or part of, the motor.

In yet another example embodiment, the pump assembly further includes a drive shaft connected to the transmission, and thus operably coupled to the motor and the power end; and the transmission is also directly connected to, or part of, the pump, such that the drive shaft is connected to, and extends between, the motor and the transmission.

In certain example embodiments, the pump assembly further includes a drive shaft connected to the transmission, and thus operably coupled to the motor and the power end; and the transmission is also directly connected to, or part of, the motor, such that the drive shaft is connected to, and extends between, the transmission and the power end.

In an example embodiment, the drive shaft includes a hollow torque tube, the hollow torque tube being adapted, when the motor produces the first rotational output, to bear torsional loads associated with the second rotational output.

In another example embodiment, the pump, the motor, and the transmission are together mounted to a skid or a trailer so that, when so mounted, the pump, the motor, and the transmission are together towable between operational sites.

In yet another example embodiment, the transmission is shiftable between first, second, third, fourth, and fifth gear configurations, which gear configurations determine the second rotational output and thus the second angular velocity.

In certain example embodiments, in the first gear configuration, the transmission has a first gear ratio ranging from about 39.2:1 to about 40.1:1; in the second gear configuration, the transmission has a second gear ratio ranging from about 28.9:1 to about 29.6:1; in the third gear configuration, the transmission has a third gear ratio ranging from about 21.3:1 to about 21.9:1; in the fourth gear configuration, the transmission has a fourth gear ratio ranging from about 15.7:1 to about 16.2:1; and in the fifth gear configuration, the transmission has a fifth gear ratio ranging from about 11.6:1 to about 12:1.

In a second aspect, there is provided an apparatus including a motor adapted to produce a first rotational output including a first angular velocity; a pump operably coupled to the motor, the pump including a fluid end and a power end operably coupled to the fluid end; and a transmission operably coupled between the motor and the pump; wherein, when the motor produces the first rotational output: the transmission is adapted to: receive the first rotational output as a first rotational input, the first rotational input including the first angular velocity; and convert the first rotational input into a second rotational output, the second rotational output including a second angular velocity; and the power end is adapted to receive the second rotational output as a second rotational input, the second rotational input including the second angular velocity.

In an example embodiment, when the motor produces the first rotational output: the power end is further adapted to convert the second rotational input into a reciprocating linear output; and the fluid end is adapted to receive the reciprocating linear output as a reciprocating linear input, wherein the reciprocating linear input draws fluid into the fluid end, pressurizes the fluid drawn into the fluid end, and discharges the pressurized fluid out of the fluid end.

In another example embodiment, the transmission is directly connected to, or part of, the pump; and the transmission is directly connected to, or part of, the motor.

In yet another example embodiment, the pump, the motor, and the transmission are together mounted to a skid or a trailer so that, when so mounted, the pump, the motor, and the transmission are together towable between operational sites.

In certain example embodiments, the transmission is shiftable between first, second, third, fourth, and fifth gear configurations, which gear configurations determine the second rotational output and thus the second angular velocity.

In an example embodiment, in the first gear configuration, the transmission has a first gear ratio ranging from about 39.2:1 to about 40.1:1; in the second gear configuration, the transmission has a second gear ratio ranging from about 28.9:1 to about 29.6:1; in the third gear configuration, the transmission has a third gear ratio ranging from about 21.3:1 to about 21.9:1; in the fourth gear configuration, the transmission has a fourth gear ratio ranging from about 15.7:1 to about 16.2:1; and, in the fifth gear configuration, the transmission has a fifth gear ratio ranging from about 11.6:1 to about 12:1.

In a third aspect, there is provided an apparatus including a motor; a pump operably coupled to the motor, the pump including a fluid end and a power end operably coupled to the fluid end; a drive shaft operably coupled to the motor and the power end; and a transmission connected to the drive shaft, and also directly connected to, or part of, either: the pump, such that the drive shaft is connected to, and extends between, the motor and the transmission; or the motor, such that the drive shaft is connected to, and extends between, the transmission and the power end.

In an example embodiment, the pump, the motor, and the transmission are together mounted to a skid or a trailer so that, when so mounted, the pump, the motor, and the transmission are together towable between operational sites.

In another example embodiment, the motor is adapted to produce a first rotational output including a first angular velocity; and, when the motor produces the first rotational output: the transmission is adapted to: receive the first rotational output as a first rotational input, the first rotational input including the first angular velocity; and convert the first rotational input into a second rotational output, the second rotational output including a second angular velocity; and the power end is adapted to receive the second rotational output as a second rotational input, the second rotational input including the second angular velocity.

In yet another example embodiment, when the motor produces the first rotational output: the power end is further adapted to convert the second rotational input into a reciprocating linear output; and the fluid end is adapted to receive the reciprocating linear output as a reciprocating linear input, wherein the reciprocating linear input draws fluid into the fluid end, pressurizes the fluid drawn into the fluid end, and discharges the pressurized fluid out of the fluid end.

In certain example embodiments, the transmission is shiftable between first, second, third, fourth, and fifth gear configurations, which gear configurations determine the second rotational output and thus the second angular velocity.

In an example embodiment, in the first gear configuration, the transmission has a first gear ratio ranging from about 39.2:1 to about 40.1:1; in the second gear configuration, the transmission has a second gear ratio ranging from about 28.9:1 to about 29.6:1; in the third gear configuration, the transmission has a third gear ratio ranging from about 21.3:1 to about 21.9:1; in the fourth gear configuration, the transmission has a fourth gear ratio ranging from about 15.7:1 to about 16.2:1; and, in the fifth gear configuration, the transmission has a fifth gear ratio ranging from about 11.6:1 to about 12:1.

Other aspects, features, and advantages will become apparent from the following detailed description when taken in conjunction with the accompanying drawings, which are a part of this disclosure and which illustrate, by way of example, principles of the embodiments disclosed.

### BRIEF DESCRIPTION OF THE FIGURES

FIG. 1 is a schematic illustration of a fracturing (or “frac”) system including a wellhead, a manifold assembly, a plurality of pump assemblies, a blender, and a fluid source, according to an example embodiment.

FIG. 2 is a schematic illustration of the manifold assembly of FIG. 1, according to an example embodiment.

FIG. 3 is a schematic illustration of one of the pump assemblies of FIG. 1, according to an example embodiment.

FIG. 4 is a schematic illustration of a pump assembly, according to another example embodiment.

FIG. 5 is a schematic illustration of a pump assembly, according to yet another example embodiment.

FIG. 6 is a schematic illustration of a pump assembly, according to still yet another example embodiment.

FIG. 7 is a flow chart illustration of a work flow for pressurizing a fluid, according to an example embodiment.

### DETAILED DESCRIPTION

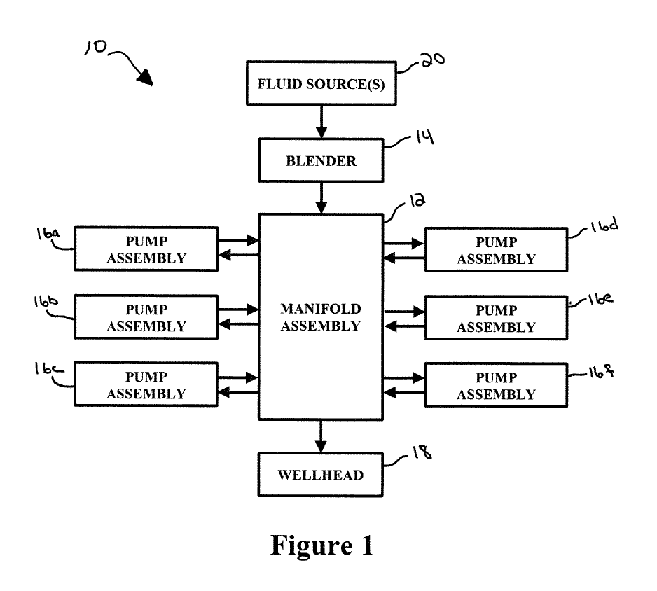

In an example embodiment, as illustrated in FIG. 1, a system is generally referred to by the reference numeral 10 and includes a manifold assembly 12. The manifold assembly 12 is in fluid communication with a blender 14, pump assemblies 16a-f, and a wellhead 18. One or more fluid sources 20 are in fluid communication with the blender 14. The wellhead 18 is located at the top or head of an oil and gas wellbore (not shown), which penetrates one or more subterranean formations (not shown), and is used in oil and gas exploration and production operations. In several example embodiments, the wellhead 18 is in fluid communication with the manifold assembly 12. In an example embodiment, the one or more fluid sources 20 include one or more fluid storage tanks, other types of fluid sources, natural water features, or any combination thereof.

In an example embodiment, the system 10 is part of a hydraulic fracturing (or “frac”) system, which may be used to facilitate oil and gas exploration and production operations. The example embodiments provided herein are not limited to a hydraulic fracturing system, as the example embodiments may be used with, or adapted to, a mud pump system, a well treatment system, other pumping systems, one or more systems at the wellhead 18, one or more systems in the wellbores of which the wellhead 18 is the surface termination, one or more systems downstream of the wellhead 18, or one or more other systems associated with the wellhead 18.

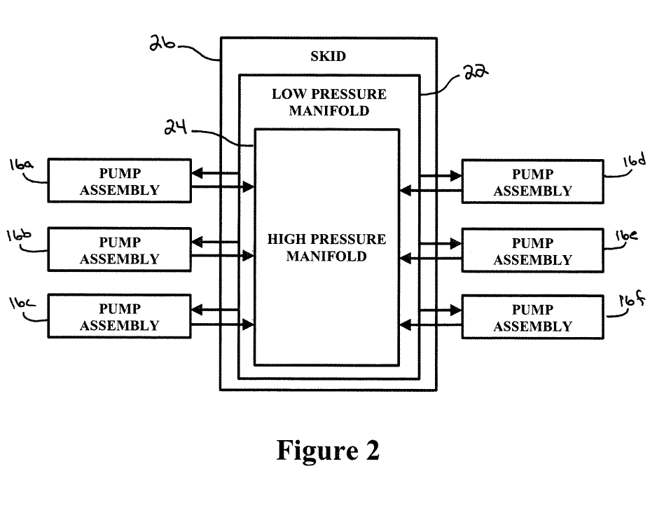

In an example embodiment, as illustrated in FIG. 2 with continuing reference to FIG. 1, the manifold assembly 12 includes a low pressure manifold 22 and a high pressure manifold 24, both of which are mounted on, and connected to, a skid 26. In several example embodiments, each of the pump assemblies 16a-f is, includes, or is part of, a positive displacement pump, a reciprocating pump assembly, a frac pump, a pump truck, a truck, a trailer, or any combination thereof. In several example embodiments, the low pressure manifold 22 includes one or more longitudinally-extending tubular members, or flow lines (not shown), that are supported by the skid 26. The flow lines of the low pressure manifold 22 are in fluid communication with the blender 14. In several example embodiments, the high pressure manifold 24 also includes one or more longitudinally-extending tubular members, or flow lines (not shown), that are supported by the skid 26.

Each of the pump assemblies 16a-f is in fluid communication with each of the low pressure manifold 22 and the high pressure manifold 24. More particularly, the pumps 16a-f are in fluid communication with the low pressure manifold 22 (for example, the flow lines of the low pressure manifold 22); such fluid communication may be effected with one or more hoses, piping, swivels, flowline components, other components, or any combination thereof. Similarly, the pumps 16a-f are in fluid communication with the high pressure manifold 24 (for example, the flow lines of the high pressure manifold 24); such fluid communication may be effected with one or more hoses, piping, swivels, flowline components, other components, or any combination thereof. In several example embodiments, with continuing reference to FIGS. 1 and 2, the high pressure manifold 24 of the manifold assembly 12 is in fluid communication with the wellhead 18.

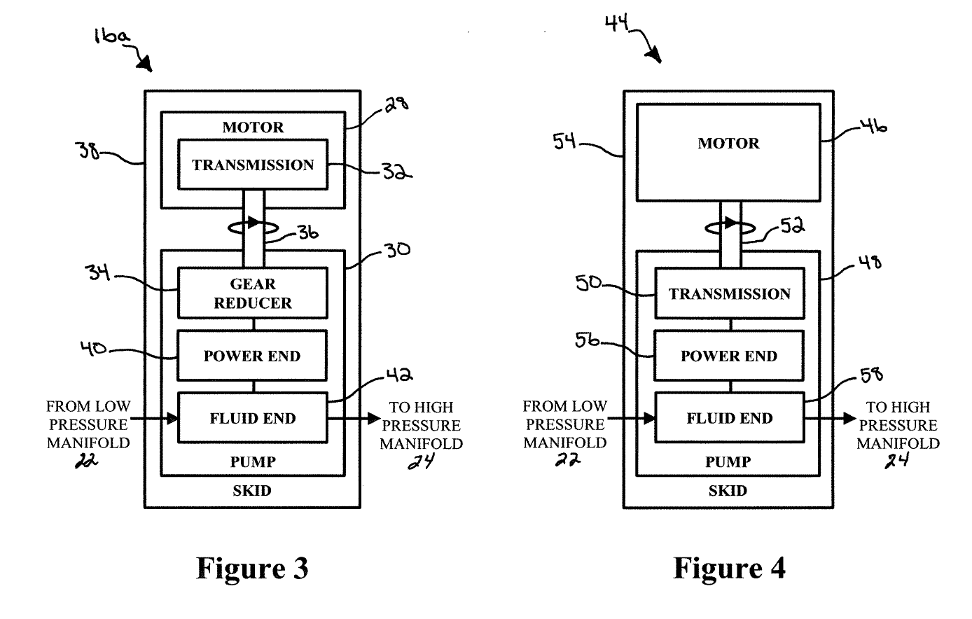

In several example embodiments, the pump assemblies 16a-f are substantially identical to one another and, therefore, in connection with FIGS. 3-6, only the pump assembly 16a will be described in detail below; however, the description below applies to every one of the pump assemblies 16a-f.

Turning to FIG. 3, with continuing reference to FIGS. 1 and 2, in an example embodiment, the pump assembly 16a includes an engine or motor 28 and a pump 30. Operably coupled to the motor 28 is a transmission 32. In several example embodiments, the transmission 32 is directly connected to, or part of, the motor 28. The transmission 32 is shiftable between a plurality of gear configurations, as will be discussed in greater detail below. Operably coupled to the pump 30 is a gear reducer 34. In several example embodiments, the gear reducer 34 is directly connected to, or part of, the pump 30. The transmission 32 and the gear reducer 34 are operably coupled to each other via a drive shaft 36. In several example embodiments, the pump assembly 16a is mounted to a skid 38. In addition to, or instead of, being mounted to the skid 38, the pump assembly 16a may be freestanding on the ground or mounted to a trailer (not shown) that can be towed between operational sites.

The pump 30 includes a power end 40 and a fluid end 42 operably coupled to the power end 40. The power end 40 includes a crankshaft (not shown) and is operably coupled to the motor 28, which is adapted to drive the crankshaft. More particularly, the power end 40 is operably coupled to the gear reducer 34, the gear reducer 34 is operably coupled to the transmission 32 via the drive shaft 36, and the transmission 32 is operably coupled to the motor 28. One or more plungers (not shown) are operably coupled to the crankshaft of the power end 40, and are adapted to reciprocate within the fluid end 42. The fluid end 42 is in fluid communication with both the low pressure manifold 22 and the high pressure manifold 24.

In some embodiments, the motor 28 drives the crankshaft, thereby causing the plungers to reciprocate within the fluid end 42. As the plungers stroke out of the fluid end 42, fluid from the low pressure manifold 22 is drawn into the fluid end 42. As the plungers stroke into the fluid end 42, the fluid is pressurized and discharged out of the fluid end 42 and into the high pressure manifold 24. The foregoing is repeated, with the pump assembly 16a pressurizing the fluid as the fluid flows from the low pressure manifold 22 to the high pressure manifold 24 via the fluid end 42. Referring back to FIGS. 1 and 2, the pump assemblies 16b-f operate in substantially the same manner as the pump assembly 16a, so that, during their collective operation, the pump assemblies 16a-f pressurize the fluid as the fluid flows from the low pressure manifold 22 to the high pressure manifold 24 via the respective fluid ends 42.

During the operation of the pump assembly 16a, the motor 28 produces a rotational output including torque and angular velocity. The torque and angular velocity output by the motor 28 are received as a rotational input by the transmission 32. The transmission 32 converts the torque and angular velocity received from the motor 28 into a rotational output including another torque and angular velocity. The transmission 32 is shiftable between first, second, third, fourth, and fifth gear configurations, which gear configurations determine the torque and angular velocity output by the transmission 32. In addition to, or instead of, the first, second, third, fourth, and fifth gear configurations, the transmission 32 may include, and be shiftable between, other gear configurations. The drive shaft 36 operably couples the transmission 32 to the gear reducer 34, and is designed to bear the torque and angular velocity output by the transmission 32. As a result, the torque and angular velocity output by the transmission 32 are received as a rotational input by the gear reducer 34. The gear reducer 34 converts the torque and angular velocity received from the transmission 32 into a rotational output including yet another torque and angular velocity. The torque and angular velocity output by the gear reducer 34 are received as a rotational input by the power end 40. The power end 40 converts the torque and angular velocity received from the gear reducer 34 into a reciprocating linear output. The fluid end 42 receives the reciprocating linear output from the power end 40 as a reciprocating linear input.

In several example embodiments, the angular velocity produced by the motor 28 during the operation of the pump assembly 16a ranges from about 1400 (RPM) to about 2200 (RPM). In several example embodiments, the angular velocity produced by the motor 28 during the operation of the pump assembly 16a ranges from about 1400 (RPM) to about 1900 (RPM). In several example embodiments, the motor 28 operates most efficiently when the angular velocity ranges from about 1400 (RPM) to about 1900 (RPM), but the motor 28 has the capability to operate with the angular velocity at 2200 (RPM) for short periods of time.

In some embodiments, when the transmission 32 is in the first gear configuration, the gear ratio of the transmission 32 ranges from about 6.1:1 to about 6.3:1. As a result, when the transmission 32 is in the first gear configuration and the angular velocity output by the motor 28 is approximately 1400 (RPM), the angular velocity output by the transmission 32 ranges from about 229.51 (RPM) to about 222.22 (RPM). In some embodiments, when the transmission 32 is in the first gear configuration and the angular velocity output by the motor 28 is approximately 1900 (RPM), the angular velocity output by the transmission 32 ranges from about 311.48 (RPM) to about 301.59 (RPM).

In some embodiments, when the transmission 32 is in the second gear configuration, the gear ratio of the transmission 32 ranges from about 4.5:1 to about 4.65:1. As a result, when the transmission 32 is in the second gear configuration and the angular velocity output by the motor 28 is approximately 1400 (RPM), the angular velocity output by the transmission 32 ranges from about 311.11 (RPM) to about 301.8 (RPM). In some embodiments, when the transmission 32 is in the second gear configuration and the angular velocity output by the motor 28 is approximately 1900 (RPM), the angular velocity output by the transmission 32 ranges from about 422.22 (RPM) to about 408.6 (RPM).

In some embodiments, when the transmission 32 is in the third gear configuration, the gear ratio of the transmission 32 ranges from about 3.32:1 to about 3.43:1. As a result, when the transmission 32 is in the third gear configuration and the angular velocity output by the motor 28 is approximately 1400 (RPM), the angular velocity output by the transmission 32 ranges from about 421.69 (RPM) to about 408.16 (RPM). In some embodiments, when the transmission 32 is in the third gear configuration and the angular velocity output by the motor 28 is approximately 1900 (RPM), the angular velocity output by the transmission 32 ranges from about 572.29 (RPM) to about 553.94 (RPM).

In some embodiments, when the transmission 32 is in the fourth gear configuration, the gear ratio of the transmission 32 ranges from about 2.45:1 to about 2.53:1. As a result, when the transmission 32 is in the fourth gear configuration and the angular velocity output by the motor 28 is approximately 1400 (RPM), the angular velocity output by the transmission 32 ranges from about 571.43 (RPM) to about 553.36 (RPM). In some embodiments, when the transmission 32 is in the fourth gear configuration and the angular velocity output by the motor 28 is approximately 1900 (RPM), the angular velocity output by the transmission 32 ranges from about 775.51 (RPM) to about 750.99 (RPM).

In some embodiments, when the transmission 32 is in the fifth gear configuration, the gear ratio of the transmission 32 ranges from about 1.81:1 to about 1.87:1. As a result, when the transmission 32 is in the fifth gear configuration and the angular velocity output by the motor 28 is approximately 1400 (RPM), the angular velocity output by the transmission 32 ranges from about 773.48 (RPM) to about 748.66 (RPM). In some embodiments, when the transmission 32 is in the fifth gear configuration and the angular velocity output by the motor 28 is approximately 1900 (RPM), the angular velocity output by the transmission 32 ranges from about 1049.7 (RPM) to about 1016.6 (RPM).

In several example embodiments, the gear ratios of the transmission 32 in the first, second, third, fourth, and fifth gear configurations (and any other gear configurations) are designed with a ratio progression that prevents, or at least reduces, any gap in reduced output speed between the lower gear ratio at approximately 1900 (RPM) and the higher gear ratio at approximately 1400 (RPM). In several example embodiments, the transmission 32 is capable of shifting between the first, second, third, fourth, and fifth gear configurations (and any other gear configurations) in both increasing and decreasing ratios under load.

In an example embodiment, as illustrated in FIG. 4 with continuing reference to FIGS. 1 and 2, one or more of the pump assemblies 16a-f are omitted in favor of another pump assembly 44. The pump assembly 44 includes an engine or motor 46 and a pump 48. In several example embodiments, the motor 46 is substantially identical to the motor 28, and is operable in substantially the same manner as described above with respect to the motor 28. Operably coupled to the pump 48 is a transmission 50, in some embodiments. In several example embodiments, the transmission 50 is directly connected to, or part of, the pump 48. In some embodiments, the transmission 50 is shiftable between a plurality of gear configurations, as will be discussed in greater detail below. In some embodiments, the shifting of the transmission 50 between the plurality of gear configurations is hydraulically controlled. The transmission 50 and the motor 46 are operably coupled to each other via a drive shaft 52. In several example embodiments, the pump assembly 44 is mounted to a skid 54. In addition to, or instead of, being mounted to the skid 54, the pump assembly 44 may be freestanding on the ground or mounted to a trailer (not shown) that can be towed between operational sites.

The pump 48 includes a power end 56 and a fluid end 58 operably coupled to the power end 56. In several example embodiments, the power end 56 and the fluid end 58 are substantially identical to the power end 40 and the fluid end 42, respectively, of the pump assembly 16a. The power end 56 is operably coupled to the transmission 50, and the transmission 50 is operably coupled to the motor 46 via the drive shaft 52. Moreover, in some embodiments, the pump assembly 44 pressurizes the fluid as the fluid flows from the low pressure manifold 22 to the high pressure manifold 24 via the fluid end 58 in substantially the same manner as described above with respect to the pump assembly 16a. Therefore, the fluid pressurization operation of the pump assembly 44 will not be described in further detail.

During the operation of the pump assembly 44, the motor 46 produces a rotational output including torque and angular velocity. The drive shaft 52 operably couples the motor 46 to the transmission 50, and is designed to bear the torque and angular velocity output by the motor 46. Thus, the torque and angular velocity output by the motor 46 are received as a rotational input by the transmission 50. The transmission 50 converts the torque and angular velocity received from the motor 46 into a rotational output including another torque and angular velocity. The transmission 50 is shiftable between first, second, third, fourth, and fifth gear configurations, which gear configurations determine the torque and angular velocity output by the transmission 50. In addition to, or instead of, the first, second, third, fourth, and fifth gear configurations, the transmission 50 may include, and be shiftable between, other gear configurations. As a result, the torque and angular velocity output by the transmission 50 are received as a rotational input by the power end 56. The power end 56 converts the torque and angular velocity received from the transmission 50 into a reciprocating linear output. The fluid end 58 receives the reciprocating linear output from the power end 56 as a reciprocating linear input.

In several example embodiments, the angular velocity produced by the motor 46 during the operation of the pump assembly 44 ranges from about 1400 (RPM) to about 2200 (RPM). In several example embodiments, the angular velocity produced by the motor 46 during the operation of the pump assembly 44 ranges from about 1400 (RPM) to about 1900 (RPM). In several example embodiments, the motor 46 operates most efficiently when the angular velocity ranges from about 1400 (RPM) to about 1900 (RPM), but the motor 46 has the capability to operate with the angular velocity at 2200 (RPM) for short periods of time.

In some embodiments, when the transmission 50 is in the first gear configuration, the gear ratio of the transmission 50 ranges from about 39.2:1 to about 40.1:1. As a result, when the transmission 50 is in the first gear configuration and the angular velocity output by the motor 46 is approximately 1400 (RPM), the angular velocity output by the transmission 50 ranges from about 35.71 (RPM) to about 34.91 (RPM). In some embodiments, when the transmission 50 is in the first gear configuration and the angular velocity output by the motor 46 is approximately 1900 (RPM), the angular velocity output by the transmission 50 ranges from about 48.47 (RPM) to about 47.38 (RPM).

In some embodiments, when the transmission 50 is in the second gear configuration, the gear ratio of the transmission 50 ranges from about 28.9:1 to about 29.6:1. As a result, when the transmission 50 is in the second gear configuration and the angular velocity output by the motor 46 is approximately 1400 (RPM), the angular velocity output by the transmission 50 ranges from about 48.44 (RPM) to about 47.3 (RPM). In some embodiments, when the transmission 50 is in the second gear configuration and the angular velocity output by the motor 46 is approximately 1900 (RPM), the angular velocity output by the transmission 50 ranges from about 65.74 (RPM) to about 64.19 (RPM).

In some embodiments, when the transmission 50 is in the third gear configuration, the gear ratio of the transmission 50 ranges from about 21.3:1 to about 21.9:1. As a result, when the transmission 50 is in the third gear configuration and the angular velocity output by the motor 46 is approximately 1400 (RPM), the angular velocity output by the transmission 50 ranges from about 65.73 (RPM) to about 63.93 (RPM). In some embodiments, when the transmission 50 is in the third gear configuration and the angular velocity output by the motor 46 is approximately 1900 (RPM), the angular velocity output by the transmission 50 ranges from about 89.2 (RPM) to about 86.76 (RPM).

In some embodiments, when the transmission 50 is in the fourth gear configuration, the gear ratio of the transmission 50 ranges from about 15.7:1 to about 16.2:1. As a result, when the transmission 50 is in the fourth gear configuration and the angular velocity output by the motor 46 is approximately 1400 (RPM), the angular velocity output by the transmission 50 ranges from about 89.17 (RPM) to about 86.42 (RPM). In some embodiments, when the transmission 50 is in the fourth gear configuration and the angular velocity output by the motor 46 is approximately 1900 (RPM), the angular velocity output by the transmission 50 ranges from about 121 (RPM) to about 117.3 (RPM).

In some embodiments, when the transmission 50 is in the fifth gear configuration, the gear ratio of the transmission 50 ranges from about 11.6:1 to about 12:1. As a result, when the transmission 50 is in the fifth gear configuration and the angular velocity output by the motor 46 is approximately 1400 (RPM), the angular velocity output by the transmission 50 ranges from about 120.7 (RPM) to about 116.7 (RPM). In some embodiments, when the transmission 50 is in the fifth gear configuration and the angular velocity output by the motor 46 is approximately 1900 (RPM), the angular velocity output by the transmission 50 ranges from about 163.8 (RPM) to about 158.3 (RPM).

In several example embodiments, the gear ratios of the transmission 50 in the first, second, third, fourth, and fifth gear configurations (and any other gear configurations) are designed with a ratio progression that prevents, or at least reduces, any gap in reduced output speed between the lower gear ratio at approximately 1900 (RPM) and the higher gear ratio at approximately 1400 (RPM). In several example embodiments, the transmission 50 is capable of shifting between the first, second, third, fourth, and fifth gear configurations (and any other gear configurations) in both increasing and decreasing ratios under load. In several example embodiments, the transmission 50 eliminates the need for the gear reducer 34. In several example embodiments, the transmission 50 includes an integrated gear reducer (not shown), and is thus referred to as a combination gear reducer and transmission.

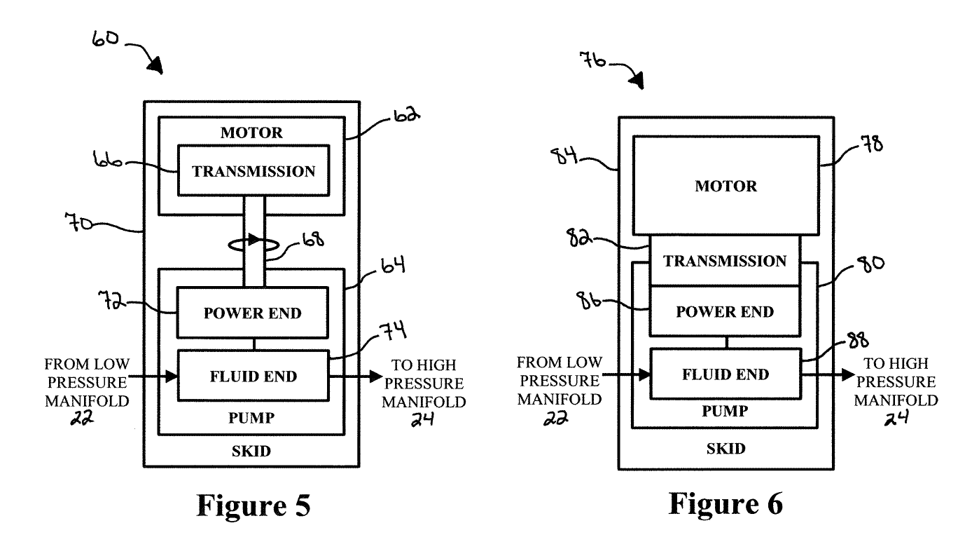

In an example embodiment, as illustrated in FIG. 5 with continuing reference to FIGS. 1 and 2, one or more of the pump assemblies 16a-f are omitted in favor of yet another pump assembly 60. The pump assembly 60 includes an engine or motor 62 and a pump 64. Operably coupled to the motor 62 is a transmission 66. In several example embodiments, the transmission 66 is directly connected to, or part of, the motor 62. The transmission 66 and the pump 64 are operably coupled to each other via a drive shaft 68. In several example embodiments, the drive shaft 68 is a hollow torque tube designed to bear the relatively large torsional loads output by the transmission 66, as will be discussed in further detail below. In several example embodiments, the motor 62 is substantially identical to the motor 28, and is operable in substantially the same manner as described above with respect to the motor 28. In several example embodiments, the transmission 66 is substantially identical to the transmission 50. Thus, the transmission 66 includes, and is shiftable between, the same gear configurations in substantially the same manner as described above with respect to the transmission 50. In several example embodiments, the pump assembly 60 is mounted to a skid 70. In addition to, or instead of, being mounted to the skid 70, the pump assembly 60 may be freestanding on the ground or mounted to a trailer (not shown) that can be towed between operational sites.

The pump 64 includes a power end 72 and a fluid end 74 operably coupled to the power end 72. In several example embodiments, the power end 72 and the fluid end 74 are substantially identical to the power end 40 and the fluid end 42, respectively, of the pump assembly 16a. The power end 72 is operably coupled to the transmission 66 via the drive shaft 68, and the transmission 66 is operably coupled to the motor 62. Moreover, in operation, the pump assembly 60 pressurizes the fluid as the fluid flows from the low pressure manifold 22 to the high pressure manifold 24 via the fluid end 74 in substantially the same manner as described above with respect to the pump assembly 16a. Therefore, the fluid pressurization operation of the pump assembly 60 will not be described in further detail.

During the operation of the pump assembly 60, the motor 62 produces a rotational output including torque and angular velocity. The torque and angular velocity output by the motor 62 are received as a rotational input by the transmission 66. The transmission 66 converts the torque and angular velocity received from the motor 62 into a rotational output including another torque and angular velocity. The drive shaft 68 operably couples the transmission 66 to the power end 72, and is designed to bear the torque and angular velocity output by the transmission 66. The torsional loads exerted on the drive shaft 68 of the pump assembly 60 are relatively large in comparison to the torsional loads exerted on the drive shaft 52 of the pump assembly 44. For this reason, in several example embodiments, the drive shaft 68 is the hollow torque tube designed to bear the relatively large torsional loads output by the transmission 66. As a result, the torque and angular velocity output by the transmission 66 are received as a rotational input by the power end 72. The power end 72 converts the torque and angular velocity received from the transmission 66 into a reciprocating linear output. The fluid end 74 receives the reciprocating linear output from the power end 72 as a reciprocating linear input.

In an example embodiment, as illustrated in FIG. 6 with continuing reference to FIGS. 1 and 2, one or more of the pump assemblies 16a-f are omitted in favor of yet another pump assembly 76. The pump assembly 76 includes an engine or motor 78 and a pump 80. Operably coupled to the motor 78 and the pump 80 is a transmission 82. In several example embodiments, the transmission 82 is directly connected to, or part of, the motor 78. In several example embodiments, the transmission 82 is directly connected to, or part of, the pump 80. In several example embodiments, the transmission 82 is directly connected to, or part of, both the motor 78 and the pump 80. In several example embodiments, the transmission 82 is directly coupled between the motor 78 and the pump 80.

In several example embodiments, the motor 78 is substantially identical to the motor 28, and is operable in substantially the same manner as described above with respect to the motor 28. In several example embodiments, the transmission 82 is substantially identical to the transmission 50. Thus, the transmission 82 includes, and is shiftable between, the same gear configurations in substantially the same manner as described above with respect to the transmission 50. In several example embodiments, the pump assembly 76 is mounted to a skid 84. In addition to, or instead of, being mounted to the skid 84, the pump assembly 76 may be freestanding on the ground or mounted to a trailer (not shown) that can be towed between operational sites.

The pump 80 includes a power end 86 and a fluid end 88 operably coupled to the power end 86. In several example embodiments, the power end 86 and the fluid end 88 are substantially identical to the power end 40 and the fluid end 42, respectively, of the pump assembly 16a. The power end 86 is operably coupled to the transmission 82, and the transmission 82 is operably coupled to the motor 78. Moreover, in operation, the pump assembly 76 pressurizes the fluid as the fluid flows from the low pressure manifold 22 to the high pressure manifold 24 via the fluid end 88 in substantially the same manner as described above with respect to the pump assembly 16a. Therefore, the fluid pressurization operation of the pump assembly 76 will not be described in further detail.

During the operation of the pump assembly 76, the motor 78 produces a rotational output including torque and angular velocity. The torque and angular velocity output by the motor 78 are received as a rotational input by the transmission 82. The transmission 82 converts the torque and angular velocity received from the motor 78 into a rotational output including another torque and angular velocity. The torque and angular velocity output by the transmission 82 are received as a rotational input by the power end 86. The power end 86 converts the torque and angular velocity received from the transmission 82 into a reciprocating linear output. The fluid end 88 receives the reciprocating linear output from the power end 86 as a reciprocating linear input.

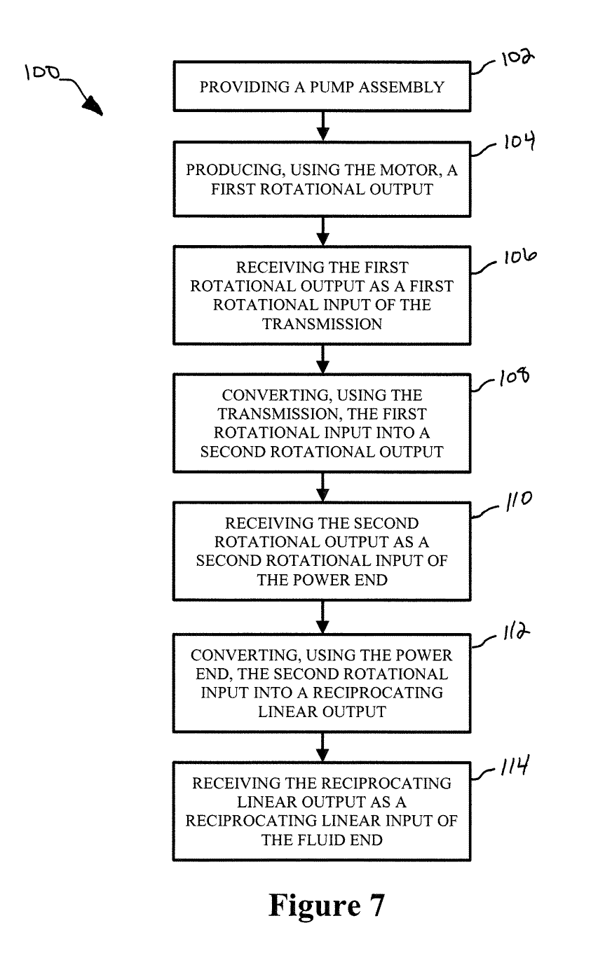

Referring now to FIG. 7, with continuing reference to FIGS. 1-6, a work flow for pressurizing a fluid is generally referred to by the reference numeral 100. In some embodiments, the work flow 100 includes providing a pump assembly at a step 102, the pump assembly including a motor, a pump operably coupled to the motor, and a transmission operably coupled between the motor and the pump, the pump including a fluid end and a power end operably coupled to the fluid end. In some embodiments, the work flow 100 includes producing, using the motor, a first rotational output at a step 104. In some embodiments, the work flow 100 includes receiving the first rotational output as a first rotational input of the transmission at a step 106. In some embodiments, the work flow 100 includes converting, using the transmission, the first rotational input into a second rotational output at a step 108. In some embodiments, the work flow 100 includes receiving the second rotational output as a second rotational input of the power end at a step 110. In some embodiments, the work flow 100 includes converting, using the power end, the second rotational input into a reciprocating linear output at a step 112. Finally, in some embodiments, the work flow 100 includes receiving the reciprocating linear output as a reciprocating linear input of the fluid end at a step 114.

In several example embodiments, the first rotational output of the step 104 includes a first angular velocity. In several example embodiments, the first rotational input of the step 106 includes the first angular velocity. In several example embodiments, the second rotational output of the step 108 includes a second angular velocity. In several example embodiments, the second rotational input of the step 110 includes the second angular velocity. In several example embodiments, the reciprocating linear input of the step 114 draws fluid into the fluid end, pressurizes the fluid drawn into the fluid end, and discharges the pressurized fluid out of the fluid end.

In several example embodiments, the pump assembly used to carry out the work flow 100 is the pump assembly 44, including the motor 46, the pump 48, the transmission 50, the power end 56, and the fluid end 58. In such embodiments, the pump assembly further includes the drive shaft 52 connected to the transmission 50, which transmission is also directly connected to, or part of, the pump 48. As a result, the drive shaft 52 is connected to, and extends between, the motor 46 and the transmission 50.

In several example embodiments, the pump assembly used to carry out the work flow 100 is the pump assembly 60, including the motor 62, the pump 64, the transmission 66, the power end 72, and the fluid end 74. In such embodiments, the pump assembly further includes the drive shaft 68 connected to the transmission 66, which transmission is also directly connected to, or part of, the motor 62. As a result, the drive shaft 68 is connected to, and extends between, the transmission 66 and the power end 72.

In several example embodiments, the pump assembly used to carry out the work flow 100 is the pump assembly 76, including the motor 78, the pump 80, the transmission 82, the power end 86, and the fluid end 88. In such embodiments, the transmission 82 is directly connected to, or part of, both the pump and the motor.

In several example embodiments, the configuration of the motor, the pump, and the transmission used to carry out the work flow 100 optimizes the efficiency of the pump assembly, thereby improving the performance of the fluid end. Such improved performance benefits operators dealing with continuous duty operations, harsh downhole environments, and multiple laterals having extended depth and reach. In several example embodiments, the configuration of the motor, the pump, and the transmission used to carry out the work flow 100 favorably affects the size and weight of the pump assembly, and thus the transportability and overall footprint of the pump assembly at the wellsite. In several example embodiments, the integrated nature of the motor, the pump, and the transmission used to carry out the work flow 100 makes it easier to inspect, service, or repair the pump assembly. In several example embodiments, the integrated nature of the motor, the pump, and the transmission used to carry out the work flow 100 makes it easier to coordinate the inspection, service, repair, or replacement of the motor, the pump, and the transmission.

It is understood that variations may be made in the foregoing without departing from the scope of the present disclosure.

In several example embodiments, the elements and teachings of the various illustrative example embodiments may be combined in whole or in part in some or all of the illustrative example embodiments. In addition, one or more of the elements and teachings of the various illustrative example embodiments may be omitted, at least in part, and/or combined, at least in part, with one or more of the other elements and teachings of the various illustrative embodiments.

Any spatial references, such as, for example, “upper,” “lower,” “above,” “below,” “between,” “bottom,” “vertical,” “horizontal,” “angular,” “upwards,” “downwards,” “side-to-side,” “left-to-right,” “right-to-left,” “top-to-bottom,” “bottom-to-top,” “top,” “bottom,” “bottom-up,” “top-down,” etc., are for the purpose of illustration only and do not limit the specific orientation or location of the structure described above.

In several example embodiments, while different steps, processes, and procedures are described as appearing as distinct acts, one or more of the steps, one or more of the processes, and/or one or more of the procedures may also be performed in different orders, simultaneously and/or sequentially. In several example embodiments, the steps, processes, and/or procedures may be merged into one or more steps, processes and/or procedures.

In several example embodiments, one or more of the operational steps in each embodiment may be omitted. Moreover, in some instances, some features of the present disclosure may be employed without a corresponding use of the other features. Moreover, one or more of the above-described embodiments and/or variations may be combined in whole or in part with any one or more of the other above-described embodiments and/or variations.

Although several example embodiments have been described in detail above, the embodiments described are exemplary only and are not limiting, and those skilled in the art will readily appreciate that many other modifications, changes and/or substitutions are possible in the example embodiments without materially departing from the novel teachings and advantages of the present disclosure. Accordingly, all such modifications, changes, and/or substitutions are intended to be included within the scope of this disclosure as defined in the following claims. In the claims, any means-plus-function clauses are intended to cover the structures described herein as performing the recited function and not only structural equivalents, but also equivalent structures. Moreover, it is the express intention of the applicant not to invoke 35 U.S.C. §112, paragraph 6 for any limitations of any of the claims herein, except for those in which the claim expressly uses the word “means” together with an associated function.

What is claimed is:

1. A method, comprising:
providing a pump assembly including a motor, a pump operably coupled to the motor, and a transmission operably coupled between the motor and the pump, the pump comprising a fluid end and a power end operably coupled to the fluid end;
producing, using the motor, a first rotational output, the first rotational output including a first angular velocity;
receiving the first rotational output as a first rotational input of the transmission, the first rotational input including the first angular velocity;
converting, using the transmission, the first rotational input into a second rotational output, the second rotational output including a second angular velocity; and
receiving the second rotational output as a second rotational input of the power end, the second rotational input including the second angular velocity.

2. The method of claim 1, further comprising: converting, using the power end, the second rotational input into a reciprocating linear output; and receiving the reciprocating linear output as a reciprocating linear input of the fluid end, wherein the reciprocating linear input draws fluid into the fluid end, pressurizes the fluid drawn into the fluid end, and discharges the pressurized fluid out of the fluid end.

3. The method of claim 1, wherein the transmission is directly connected to, or part of, the pump; and wherein the transmission is directly connected to, or part of, the motor.

4. The method of claim 1,
wherein the pump assembly further comprises a drive shaft connected to the transmission, and thus operably coupled to the motor and the power end; and
wherein the transmission is also directly connected to, or part of, the pump, such that the drive shaft is connected to, and extends between, the motor and the transmission.

5. The method of claim 1,
wherein the pump assembly further comprises a drive shaft connected to the transmission, and thus operably coupled to the motor and the power end;
wherein the transmission is also directly connected to, or part of, the motor, such that the drive shaft is connected to, and extends between, the transmission and the power end; and
wherein the drive shaft includes a hollow torque tube, the hollow torque tube being adapted, when the motor produces the first rotational output, to bear torsional loads associated with the second rotational output.

6. The method of claim 1, wherein the pump, the motor, and the transmission are together mounted to a skid or a trailer so that, when so mounted, the pump, the motor, and the transmission are together towable between operational sites.

7. The method of claim 1, wherein the transmission is shiftable between first, second, third, fourth, and fifth gear configurations, which gear configurations determine the second rotational output and thus the second angular velocity.

8. The method of claim 7, wherein, in the first gear configuration, the transmission has a first gear ratio ranging from about 39.2:1 to about 40.1:1;
wherein, in the second gear configuration, the transmission has a second gear ratio ranging from about 28.9:1 to about 29.6:1;
wherein, in the third gear configuration, the transmission has a third gear ratio ranging from about 21.3:1 to about 21.9:1;
wherein, in the fourth gear configuration, the transmission has a fourth gear ratio ranging from about 15.7:1 to about 16.2:1; and
wherein, in the fifth gear configuration, the transmission has a fifth gear ratio ranging from about 11.6:1 to about 12:1.

9. An apparatus, comprising:
a motor adapted to produce a first rotational output including a first angular velocity;
a pump operably coupled to the motor, the pump comprising a fluid end and a power end operably coupled to the fluid end; and
a transmission operably coupled between the motor and the pump;
wherein, when the motor produces the first rotational output:
the transmission is adapted to:
receive the first rotational output as a first rotational input, the first rotational input including the first angular velocity; and
convert the first rotational input into a second rotational output, the second rotational output including a second angular velocity;
and
the power end is adapted to receive the second rotational output as a second rotational input, the second rotational input including the second angular velocity.

10. The apparatus of claim 9, wherein, when the motor produces the first rotational output:
the power end is further adapted to convert the second rotational input into a reciprocating linear output; and
the fluid end is adapted to receive the reciprocating linear output as a reciprocating linear input, wherein the reciprocating linear input draws fluid into the fluid end, pressurizes the fluid drawn into the fluid end, and discharges the pressurized fluid out of the fluid end.

11. The apparatus of claim 9, wherein the transmission is directly connected to, or part of, the pump; and wherein the transmission is directly connected to, or part of, the motor.

12. The apparatus of claim 9, wherein the pump, the motor, and the transmission are together mounted to a skid or a trailer so that, when so mounted, the pump, the motor, and the transmission are together towable between operational sites.

13. The apparatus of claim 9, wherein the transmission is shiftable between first, second, third, fourth, and fifth gear configurations, which gear configurations determine the second rotational output and thus the second angular velocity.

14. The apparatus of claim 13, wherein, in the first gear configuration, the transmission has a first gear ratio ranging from about 39.2:1 to about 40.1:1;
wherein, in the second gear configuration, the transmission has a second gear ratio ranging from about 28.9:1 to about 29.6:1;
wherein, in the third gear configuration, the transmission has a third gear ratio ranging from about 21.3:1 to about 21.9:1;
wherein, in the fourth gear configuration, the transmission has a fourth gear ratio ranging from about 15.7:1 to about 16.2:1; and
wherein, in the fifth gear configuration, the transmission has a fifth gear ratio ranging from about 11.6:1 to about 12:1.

15. An apparatus, comprising:
a motor;
a pump operably coupled to the motor, the pump comprising a fluid end and a power end operably coupled to the fluid end;
a drive shaft operably coupled to the motor and the power end; and
a transmission connected to the drive shaft, and also directly connected to, or part of, either:
the pump, such that the drive shaft is connected to, and extends between, the motor and the transmission; or
the motor, such that the drive shaft is connected to, and extends between, the transmission and the power end.

16. The apparatus of claim 15, wherein the pump, the motor, and the transmission are together mounted to a skid or a trailer so that, when so mounted, the pump, the motor, and the transmission are together towable between operational sites.

17. The apparatus of claim 15, wherein the motor is adapted to produce a first rotational output including a first angular velocity; and
wherein, when the motor produces the first rotational output:
the transmission is adapted to:
receive the first rotational output as a first rotational input, the first rotational input including the first angular velocity; and
convert the first rotational input into a second rotational output, the second rotational output including a second angular velocity;
and
the power end is adapted to receive the second rotational output as a second rotational input, the second rotational input including the second angular velocity.

18. The apparatus of claim 17, wherein, when the motor produces the first rotational output:
the power end is further adapted to convert the second rotational input into a reciprocating linear output; and
the fluid end is adapted to receive the reciprocating linear output as a reciprocating linear input, wherein the reciprocating linear input draws fluid into the fluid end, pressurizes the fluid drawn into the fluid end, and discharges the pressurized fluid out of the fluid end.

19. The apparatus of claim 17, wherein the transmission is shiftable between first, second, third, fourth, and fifth gear configurations, which gear configurations determine the second rotational output and thus the second angular velocity.

20. The apparatus of claim 19, wherein, in the first gear configuration, the transmission has a first gear ratio ranging from about 39.2:1 to about 40.1:1;
wherein, in the second gear configuration, the transmission has a second gear ratio ranging from about 28.9:1 to about 29.6:1;
wherein, in the third gear configuration, the transmission has a third gear ratio ranging from about 21.3:1 to about 21.9:1;
wherein, in the fourth gear configuration, the transmission has a fourth gear ratio ranging from about 15.7:1 to about 16.2:1; and
wherein, in the fifth gear configuration, the transmission has a fifth gear ratio ranging from about 11.6:1 to about 12:1.
